(19) United States
(12) Patent Application Publication
(10) Pub. No.: US 2012/0092507 A1
(43) Pub. Date: Apr. 19, 2012

(54) USER EQUIPMENT, AUGMENTED REALITY (AR) MANAGEMENT SERVER, AND METHOD FOR GENERATING AR TAG INFORMATION

(75) Inventors: Ho Ryong JUNG, Seoul (KR); Ho Ryun LEE, Seoul (KR); Seung Tek LEE, Anyang-si (KR); Jai Young CHOI, Seoul (KR); Jung Sick KIM, Goyang-si (KR); Ju Hee HWANG, Ansan-si (KR); Sang Keun HAN, Anyang-si (KR)

(73) Assignee: PANTECH CO., LTD., Seoul (KR)

(21) Appl. No.: 13/212,981

(22) Filed: Aug. 18, 2011

(30) Foreign Application Priority Data
Oct. 13, 2010 (KR) 10-2010-0100007

(51) Int. Cl. H04N 5/262; H04N 5/225

(52) U.S. Cl. 348/207.1; 348/239; 348/E05.051; 348/E05.024

(57) ABSTRACT

A user equipment to generate augmented reality (AR) tag information includes a photographing unit to capture an image of a target object, an information collecting unit to collect contextual information when the photographing unit captures the image of the target object, and a control unit to generate AR tag information of the target object based on the contextual information. A method for generating AR tag information in a user equipment includes capturing an image of a target object, collecting contextual information when capturing the image of the target object, and generating AR tag information of the target object based on the contextual information.

### CROSS-REFERENCE TO RELATED APPLICATION

This application claims priority from and the benefit under 35 U.S.C. §119(a) of Korean Patent Application No. 10-2010-0100007, filed on Oct. 13, 2010, which is incorporated by reference for all purposes as if fully set forth herein.

### BACKGROUND

1. Field

The following description relates to a user equipment, an augmented reality (AR) management server, and a method for generating AR tag information, in which a user may generate AR tag information based on an azimuth.

2. Discussion of the Background

Augmented reality (AR) is a computer graphic technology for combining a real world environment with a virtual object or virtual information. Unlike a general virtual reality technology that provides virtual objects in a virtual space, the AR technology combines the real world environment with the virtual object or virtual information, thereby adding supplementary information that may be difficult to obtain in the real world environment. The AR technology may apply a filter to the identified objects in the real world environment to filter a target virtual object or virtual information sought by the user from the real environment.

However, there may be a limitation on how much information may be provided through a conventional AR service. Generally, the conventional AR service may provide basic information through AR technology using global positioning system (GPS) information of an object. That is, the conventional AR service may provide the same information even if there is a change in a location of a user looking at the object.

### SUMMARY

Exemplary embodiments of the present invention provide a user equipment, an augmented reality (AR) management server, and a method for generating augmented reality (AR) tag information, in which an AR tag may be generated based on an azimuth toward a target object viewed by a user.

Additional features of the invention will be set forth in the description which follows, and in part will be apparent from the description, or may be learned by practice of the invention.

Exemplary embodiments of the present invention provide a user equipment to generate AR tag information including a photographing unit to capture a first image of a target object, an information collecting unit to collect first contextual information when the photographing unit captures the first image of the target object, the first contextual information including a first location information of the photographing unit and a first azimuth information between the target object and the photographing unit, and a control unit to generate first AR tag information of the target object based on the first contextual information.

Exemplary embodiment of the present invention provide a method for generating AR tag information in a user equipment including capturing a first image of a target object, collecting first contextual information when capturing the first image of the target object, the first contextual information including a first location information of the user equipment and a first azimuth information between the target object and the user equipment, and generating AR tag information of the target object based on the collected contextual information.

Exemplary embodiment of the present invention provide an AR management server including a communication unit to receive AR tag information and contextual information, the contextual information including azimuth information and location information for a user equipment when an image is captured of a target object corresponding to the AR tag information, and an information processing unit to map the AR tag information to the contextual information and to store the mapping information in a database.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a user equipment to generate augmented reality (AR) tag information according to an exemplary embodiment of the invention.

FIG. 2 is a block diagram illustrating a user equipment to generate AR tag information according to an exemplary embodiment of the invention.

FIG. 3 is a block diagram illustrating an information collecting unit and an information analysis unit according to an exemplary embodiment of the invention.

FIG. 4A, FIG. 4B, and FIG. 4C are views illustrating an AR tag information based on an azimuth displayed on a display unit according to an exemplary embodiment of the invention.

FIG. 5 is a block diagram of an AR management server according to an exemplary embodiment of the invention.

FIG. 6 is a flowchart illustrating a method for generating AR tag information in a user equipment according to an exemplary embodiment of the invention.

FIG. 7 is a flowchart illustrating a method for managing AR tag information in an AR management server according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

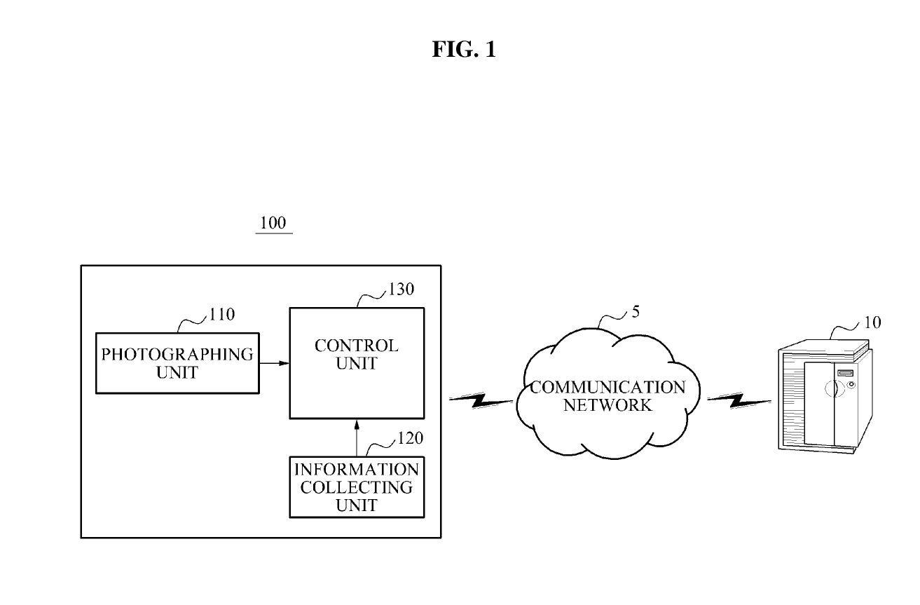

FIG. 1 is a block diagram illustrating a user equipment to generate augmented reality (AR) tag information according to an exemplary embodiment of the invention.

As shown in FIG. 1, the first user equipment 100 includes a photographing unit 110, an information collecting unit 120, and a control unit 130.

The photographing unit 110 may capture an image of a target object. In an example, the photographing unit 110 may be an embedded camera or an external camera. The captured image may be treated as a displayable signal by the photographing unit 110 or by a separate image processor.

The information collecting unit 120 may collect contextual information including information about a current location of the user equipment 100, information about a direction, such as a direction measured relative to true north or magnetic north, from the photographing unit 110 to the target object, a tilt information of the user equipment 100, and azimuth information between the user equipment 100 and the target object. The contextual information may be collected at any time, such as at regular intervals, upon a direct or indirect command of a user, or at the time the image is captured by the photographing unit 110. The tilt information may be information about the tilt position of the user equipment 100 when the image is captured. The user equipment 100 may be tilted in various directions before the user equipment 100 may capture the target object. The azimuth information may include a numeric value of an azimuth between the user equipment 100 and the target object. In an example, azimuth may reference an angle measured up from the horizon. That is, the azimuth may include an angle from a reference point on the user equipment 100 to the target object, measured relative to the horizon. The reference point on the user equipment 100 may be defined as an upper point, edge, or surface, or lower point, edge, or surface, or may be defined from a focal lens of the photographing unit 110.

The control unit 130 may process the location information, direction information, tilt information, and azimuth information collected by the information collecting unit 120 to generate contextual information. Also, the control unit 130 may generate AR tag information of the target object. That is, the AR tag information may be generated based on an azimuth measured at the time the image of the target object is captured.

The control unit 130 may control a communication module (not shown) to transmit the generated AR tag information and the contextual information to an AR management server 10 via a communication network 5.

The AR management server 10 may map the AR tag information received from the user equipment 100 to the received contextual information and may store the mapping information.

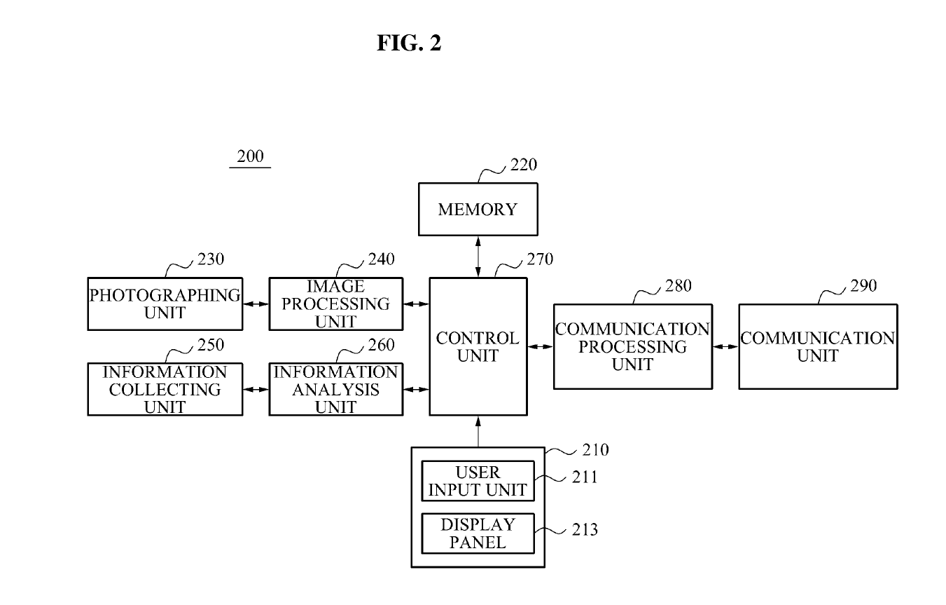

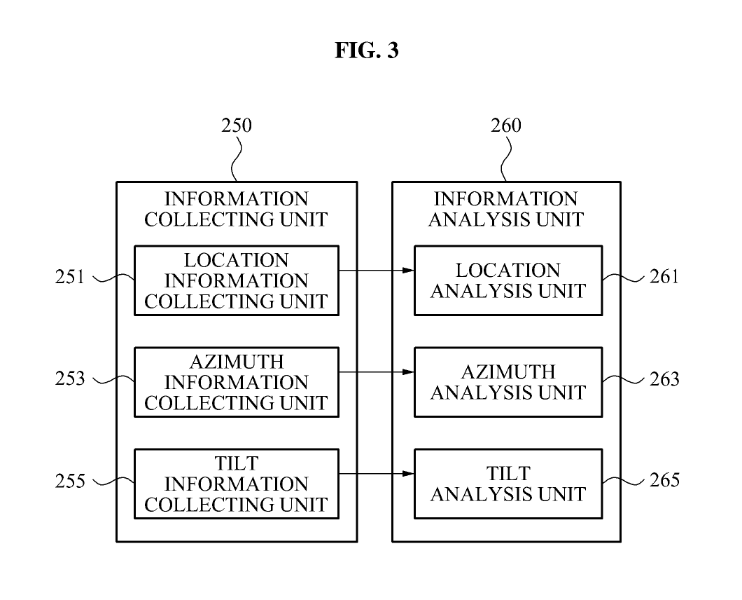

FIG. 2 is a block diagram illustrating a user equipment to generate AR tag information according to an exemplary embodiment of the invention. FIG. 3 is a block diagram illustrating an information collecting unit and an information analysis unit according to an exemplary embodiment of the invention.

As shown in FIG. 2, the user equipment 200 includes a user interface (UI) unit 210, a memory 220, a photographing unit 230, an image processing unit 240, an information collecting unit 250, an information analysis unit 260, a control unit 270, a communication processing unit 280, and a communication unit 290.

The UI unit 210 may provide a user with the ability to interface with the user equipment 200, and may include a user input unit 211 and a display panel 213.

The user input unit 211 may be a manipulation panel to receive an input of a user command, and may include one or more of various interfaces. For example, interfaces may include a button to photograph a target object, a direction key, a touch panel, and the like. In particular, a user may make a request to enter an AR tag information generating mode to input additional information of the target object. In addition, the user may also make a request to input AR tag information by manipulating the user input unit 211. The control unit 270 described below may generate AR tag information using the additional information of the target object.

If an image inputted from the photographing unit 230 is recognized as an input signal, the display panel 213 may display the signal-processed image. If the user equipment 200 provides a touch-based input method, the display panel 213 may display a UI for a touch panel associated with the display panel 213 to receive user input.

The memory 220 may store a program used to enable an operation of the user equipment 200, various data and information, and the like. In particular, the memory 220 may store AR tag information of a target object, which may include the additional information inputted by the user, mapped to contextual information of the target object.

The photographing unit 230 may capture an image of the target object. In an example, the photographing unit 230 includes an embedded camera or an external camera. The obtained image may include the target object. If a user captures a front image, a lateral image or a rear image of the target object, the control unit 270 described below may generate AR tag information corresponding to one or more of the front image, the lateral image, or the rear image of the target object.

The image processing unit 240 may analyze the image captured by the photographing unit 230, and may treat the image as a displayable signal using the analysis result. In an example, the image processing unit 240 may be an image processor.

The information collecting unit 250 may collect contextual information including information about a location, a tilt information, and an azimuth of the user equipment 200. Referring to FIG. 3, the information collecting unit 250 may include a location information collecting unit 251, an azimuth information collecting unit 253, and a tilt information collecting unit 255.

The location information collecting unit 251 may collect location information about a location of the user equipment 200 and direction information about a direction toward the target object viewed or when the image including the target object was originally captured by the photographing unit 230. Also, the location information collecting unit 251 may further collect location information of the target object. In an example, the location information collecting unit 251 may sense and collect a location using a global positioning system (GPS), a location-based service (LBS), and the like. Further, the location information collecting unit 251 may also sense and collect a direction using a digital compass. The location information and the direction information collected by the location information collecting unit 251 may be provided to a location analysis unit 261.

The azimuth information collecting unit 253 may collect azimuth information between the user equipment 200 and the target object. The azimuth information collected by the azimuth information collecting unit 253 may be provided to an azimuth analysis unit 263.

The tilt information collecting unit 255 may collect tilt information of the user equipment 200 when the image is captured. The tilt information may be information about the tilt position of the user equipment 200 when the image is captured. The user equipment 200 may be tilted in various directions by manipulation of a user before the user equipment 200 may capture the target object. In an example, the tilt information collecting unit 255 may sense and collect tilt information using a six-axis motion sensor including a three-axis Gyroscope sensor and a three-axis (x, y, z) acceleration sensor. The tilt information collected by the tilt information collecting unit 255 may be provided to a tilt analysis unit 265.

The information analysis unit 260 may analyze information collected by the information collecting unit 250 as a processible signal. As shown in FIG. 3, the information analysis unit 260 includes a location analysis unit 261, an azimuth analysis unit 263, and a tilt analysis unit 265.

The location analysis unit 261 may analyze the location information and direction information collected by the location information collecting unit 251 as a processible signal.

The azimuth analysis unit 263 may analyze the azimuth information collected by the azimuth information collecting unit 253 as a processible signal.

The tilt analysis unit 265 may analyze the tilt information collected by the tilt information collecting unit 255 as a processible signal.

Referring back to FIG. 2, the control unit 270 may generate AR tag information of the target object using additional information of the target object inputted through the user input unit 211. In an example, the additional identifying information corresponding to the image that is captured, such as a particular view of the target object (e.g., front view, left view, right view, rear view, etc.), name of the target object, nearby landmark, and the like. Further, the additional information may be provided automatically or manually as part of the contextual information or independent of the contextual information. The contextual information may include azimuth information between the photographing unit 230 and the target object as described above.

In an example, the control unit 270 may automatically generate additional information, and may generate AR tag information using the additional information. For example, if additional information of the target object is not received from a user, the control unit 270 may generate AR tag information using a current date, contextual information, and the like.

In addition, if additional information of the target object is not received from a user, the control unit 270 may terminate the generation of AR tag information.

The control unit 270 may map AR tag information of the target object to contextual information analyzed by the information analysis unit 260 and store the mapping information in the memory 220. Further, the control unit 270 may control the communication unit 290 to transmit the AR tag information to an AR management server 500. Accordingly, AR tag information generated in response to a request of a user may be stored and managed for one or more contextual information. As described above, the contextual information may include at least one of location information, direction information, tilt information, and azimuth information measured when an image of the target object is captured.

The communication processing unit 280 may convert AR tag information of the target object and contextual information related to the target object into data based on a transmission protocol by the control of the control unit 270.

The communication unit 290 may transmit data inputted from the communication processing unit 280 to the AR management server 500 via a communication network.

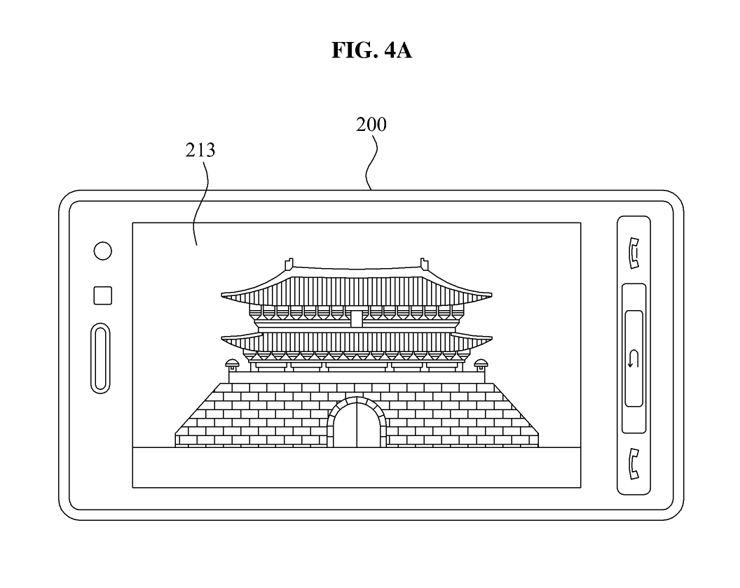

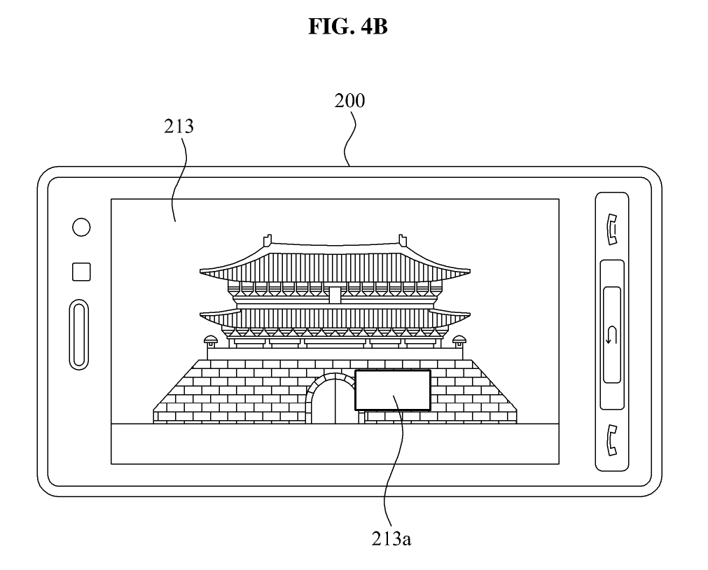

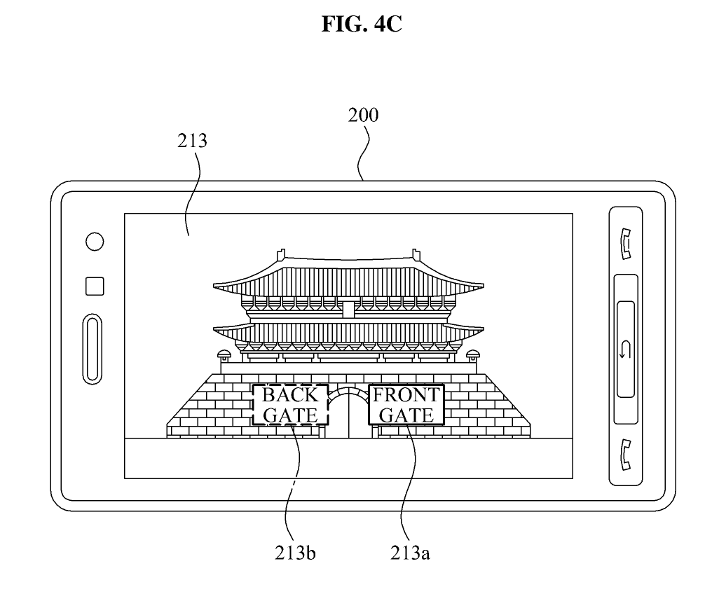

FIG. 4A, FIG. 4B, and FIG. 4C are views illustrating a process for generating AR tag information based on an azimuth according to an exemplary embodiment of the invention.

Referring to FIG. 4A, if a user captures ‘Namdaemun’ using the photographing unit 230 of the user equipment 200, the display panel 213 may display the target object ‘Namdaemun’.

If the user makes a request to generate AR tag information of the displayed target object by manipulating the user input unit 211, or if the user captures the displayed target object for a reference period of time, the control unit 270 may generate an input window 213a on the display panel 213 to input additional information of the target object as shown in FIG. 4B.

The user may input additional information through the input window 213a. Referring to FIG. 4C, the user has inputted ‘front gate’ as additional information of a currently displayed target object. Accordingly, the inputted ‘front gate’ may be generated as AR tag information and the inputted information, ‘front gate’ may be stored in the memory 220 or in the AR management server 500, together with contextual information including collected azimuth information.

Also, after the user moves and captures a lateral image or a rear image of the ‘Namdaemun’, the user may input new additional information. For example, after the user captures a rear image of the ‘Namdaemun’, the user may input ‘back gate’ as additional information in the input window 213b. The inputted ‘back gate’ may be mapped to contextual information collected at a location where the rear image of the ‘Namdaemun’ was captured, and may be stored as AR tag information. In other words, the user may capture the target object at multiple locations or with different azimuths, and may generate corresponding AR tag information for each location and each azimuth.

If the user captures the ‘Namdaemun’ again after the user moves to the former location where the user inputted the ‘front gate’, the control unit 270 may control the information collecting unit 250 to collect contextual information including current location information and azimuth information and display the corresponding image. More specifically, AR tag information corresponding to the collected contextual information, including the previously inputted additional information, the ‘front gate’, may be displayed on the display panel 213 according to the user's current location. In this instance, if the user is at the ‘front gate’ location, the control unit 270 may also display the AR tag information 213b with the label ‘back gate’ in a dotted line as shown in FIG. 4C. Alternatively, the AR tag information 213b may not be displayed at all while the user is at the ‘front gate’ location. Accordingly, if the user touches the ‘back gate’ indicated in a dotted line, the control unit 270 may display the target object corresponding to the ‘back gate’, that is, a back gate of the ‘Namdaemun’ on the display panel 213.

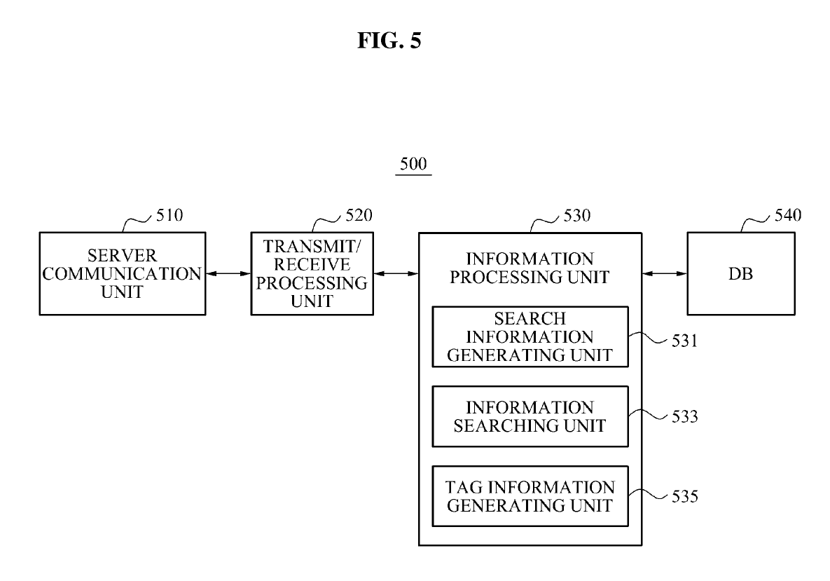

FIG. 5 is a block diagram of an AR management server according to an exemplary embodiment of the invention.

Referring to FIG. 5, an AR management server 500 may store and manage AR tag information generated by one or more user equipments, together with contextual information. As shown in FIG. 5, the AR management server 500 includes a server communication unit 510, a transmit/receive processing unit 520, an information processing unit 530, and a database (DB) 540.

The server communication unit 510 may communicate with one or more user equipments including the user equipment 200 via a communication network. Hereinafter, description is made using the user equipment 200 as an example, but the AR management server 500 is not limited as such.

The server communication unit 510 may receive AR tag information and contextual information from the user equipment 200. The contextual information may include location information, azimuth information, and tilt information used to capture a target object related to the AR tag information.

The transmit/receive processing unit 520 may determine whether the received AR information and the received contextual information is available. The transmit/receive processing unit 520 may also determine whether an error has occurred in receiving the AR tag information and the contextual information or whether the AR tag information and the contextual information contains improper information. If the AR tag information and the contextual information is determined to be available, the transmit/receive processing unit 520 may provide the AR tag information and the contextual information to the information processing unit 530.

The information processing unit 530 may process the AR tag information and the contextual information into a storable data, and may act as a control unit or a processor. As shown in FIG. 5, the information processing unit 530 includes a search information generating unit 531, an information searching unit 533, and a tag information generating unit 535.

The search information generating unit 531 may set search information to query the DB 540. The search information may be used to search whether AR tag information corresponding to contextual information corresponding to the received contextual information is stored in the DB 540. In an example, the compared information may be considered to correspond if they are similar, such as within a range, or the same as one another. The search information generating unit 531 may set search information by processing the AR tag information and the contextual information received from the transmit/receive processing unit 520. Accordingly, the search information generating unit 531 may generate the search information in a type of a header.

The information searching unit 533 may search the DB 540 using the search information to check whether corresponding search information is stored in the DB 540. More specifically, if the location information included in the search information corresponds to location information stored in the DB 540, the information searching unit 533 may check whether the stored location information is stored together with the azimuth information in the DB 540.

If the location information is stored together with azimuth information, the information searching unit 533 may update information stored in the DB 540 using the AR tag information included in the search information. More specifically, the AR tag information generated by the user equipment 200 may be mapped to the stored contextual information or to new contextual information stored in the DB 540. The AR information stored in the DB 540 may be shared by one or more user equipments.

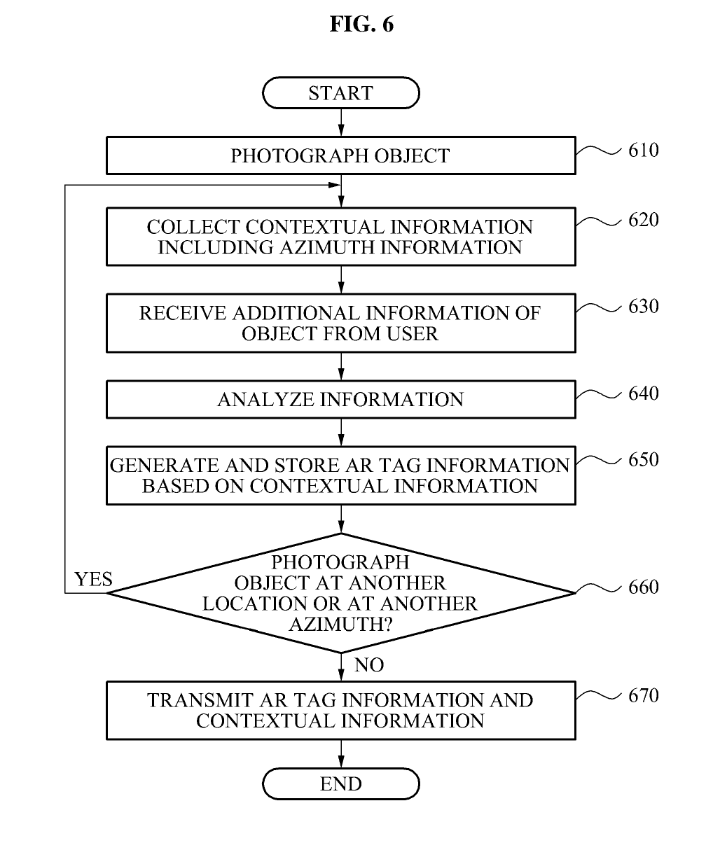

FIG. 6 is a flowchart illustrating a method for generating AR tag information in a user equipment according to an exemplary embodiment of the invention.

For convenience, one or more operation of the method disclosed in FIG. 6 will be described as if the method was performed by the user equipment 100 or user equipment 200 or by a control unit or a processor of the user equipment 100 or user equipment 200. However, the method is not limited as such.

In operation 610, a user may capture an image including a target object using a camera to generate AR tag information.

In operation 620, the user equipment may collect contextual information related to the target object. In an example, the contextual information may include at least one of location information of the user equipment by which the target object was captured, azimuth information between the target object and the camera, and tilt information of the user equipment. The user equipment may collect contextual information related to the target object when the image of the target object is captured by the camera.

In operation 630, the user equipment may receive an input of additional information of the target object from the user. If additional information is not received from the user, the user equipment may terminate the generation of AR tag information or may automatically generate additional information based on available information, such as date, time, name of the target object, nearby landmark or the like.

In operation 640, the user equipment may analyze the contextual information collected in operation 620 and the additional information received in operation 630.

In operation 650, the user equipment may generate the AR tag information using the received additional information, and may map the generated AR tag information to the contextual information and store the mapping information.

If the user captures the same target object at another location or at another azimuth in operation 660, the user equipment may repeat operation 620, operation 630, operation 640, and operation 650. That is, the user equipment may collect contextual information corresponding to the other location or the other azimuth, receive additional information from the user, analyze the information, and generate AR tag information based on the collected contextual information and additional information.

In operation 670, the user equipment may merge the generated AR tag information and the contextual information into a data and may transmit the data to an AR management server. Accordingly, the AR tag information and the contextual information may be stored and managed in the AR management server and may be shared by other users.

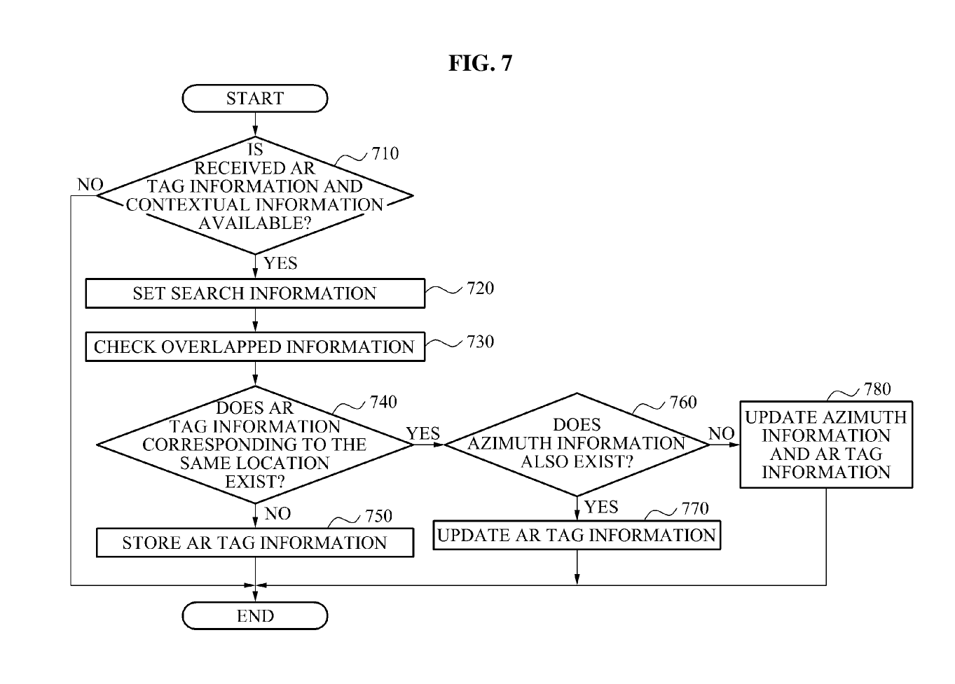

FIG. 7 is a flowchart illustrating a method for managing AR tag information in an AR management server according to an exemplary embodiment of the invention.

For convenience, one or more operations of the method disclosed in FIG. 7 will be described as if the method was performed by the AR management server 10 or AR management server 500 or by a control unit or a processor of the AR management server 10 or AR management server 500. However, the method is not limited as such.

In operation 710, the AR management server may determine a) whether AR tag information and contextual information received from the user equipment exists, and b) whether the AR tag information and contextual information has error in them. For example, if the AR management server determines AR tag information and contextual information received from the user equipment does exist and the respective information have no error in them, the AR tag information and contextual information may be determined to be available.

If AR tag information and contextual information received from the user equipment is determined as being available, the AR management server may set search information for a query to the DB in operation 720. In an example, the search information may be used to search whether AR tag information corresponding to stored contextual information matches the AR tag information corresponding to the received contextual information.

In operation 730, the AR management server may check whether overlapped information exists in the DB, using the search information.

If the location information included in the received contextual information does not have matching location information stored in the DB in operation 740, the AR management server may convert the received AR tag information into a storable data and may map the data to the received contextual information and store in the DB, in operation 750.

Alternatively, if location information included in the received contextual information does have corresponding location information stored in the DB in operation 740, the AR management server checks whether corresponding azimuth information mapped to the corresponding location information exists in operation 760. The corresponding azimuth information may be the azimuth information included in the search information or in the contextual information.

If corresponding azimuth information is available in operation 760, the AR management server may update the stored information mapped to the location information and the azimuth information using the received AR tag information in operation 770.

If corresponding location information is available and the corresponding azimuth information is not available in operation 760, the AR management server may update the stored information mapped to the corresponding location information using the received AR tag information. Further, the AR management server may store azimuth information of the received contextual information together with the location information in the DB, in operation 780.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A user equipment to generate augmented reality (AR) tag information, comprising:
a photographing unit to capture a first image of a target object;
an information collecting unit to collect first contextual information when the photographing unit captures the first image of the target object, the first contextual information comprising a first location information of the photographing unit and a first azimuth information between the target object and the photographing unit; and
a control unit to generate first AR tag information of the target object based on the first contextual information.

2. The user equipment of claim 1, further comprising:
a user input unit to receive a user input of a first additional information of the first image,
wherein the control unit generates first AR tag information of the target object based on the first contextual information and the first additional information.

3. The user equipment of claim 2, wherein the photographing unit captures a second image of the target object, and the control unit generates second AR tag information corresponding to the second image, the second AR tag information comprising second contextual information being different than the first contextual information.

4. The user equipment of claim 3, further comprising:
a display unit to display the second AR tag information of the target object,
wherein the first additional information of the target object is displayed as a first selectable tag if the photographing unit captures the second image of the target object at a second location or a second azimuth.

5. The user equipment of claim 1, wherein the information collecting unit comprises:
a location information collecting unit to collect the first location information; and
an azimuth information collecting unit to collect the first azimuth information.

6. The user equipment of claim 1, wherein the first contextual information further comprises tilt information of at least one of the photographing unit and the user equipment when the photographing unit captures the first image of the target object.

7. The user equipment of claim 1, further comprising:
a communication unit to transmit the first AR tag information and the first contextual information to an AR management server,
wherein the AR management server maps the first AR tag information received from the communication unit to the first contextual information, and stores the mapping information.

8. A method for generating augmented reality (AR) tag information in a user equipment, comprising:
capturing a first image of a target object;
collecting first contextual information when capturing the first image of the target object, the first contextual information comprising a first location information of the user equipment and a first azimuth information between the target object and the user equipment; and
generating first AR tag information of the target object based on the first contextual information.

9. The method of claim 8, further comprising:
receiving a user input of first additional information of the first image; and
generating first AR tag information of the target object based on the first contextual information and the first additional information.

10. The method of claim 9, further comprising capturing a second image of the target object, and generating second AR tag information corresponding to the second image, the second AR tag information comprising second contextual information being different than the first contextual information.

11. The method of claim 10, further comprising:
displaying the second AR tag information of the target object,
wherein the first additional information of the target object is displayed as a first selectable tag if the user captures the second image of target object at a second location or a second azimuth.

12. The method of claim 8, wherein the first contextual information further comprises tilt information of the user equipment.

13. The method of claim 8, further comprising:
transmitting the first AR tag information and the first contextual information to an AR management server,
wherein the AR management server maps the first AR tag information to the first contextual information, and stores the mapping information.

14. An augmented reality (AR) management server, comprising:
a communication unit to receive AR tag information and contextual information, the contextual information comprising azimuth information and location information for a user equipment when an image is captured of a target object corresponding to the AR tag information; and
an information processing unit to map the AR tag information to the contextual information and to store the mapping information in a database.

15. The AR management server of claim 16, wherein the AR tag information comprises additional information received by the user equipment.
